(19) United States
(12) Patent Application Publication
(10) Pub. No.: US 2013/0262200 A1
(43) Pub. Date: Oct. 3, 2013

(54) Method and Apparatus for the identification of products displayed in media programs

(71) Applicant: Gadge Brown, New York, NY (US)

(72) Inventor: Gadge Brown, New York, NY (US)

(21) Appl. No.: 13/437,754

(22) Filed: Apr. 2, 2012

(51) Int. Cl. G06Q 30/02

(52) U.S. Cl. CPC G06Q 30/0241
USPC 705/14.4

(57) ABSTRACT

A method and apparatus for the identification of products in a media program and making such products available for consumer purchase is presented. A consumer utilizes a “BeamBack” device to initiate a “screen grab” and thereby express interest in a placed and/or advertised product. An identifying marker is transmitted in response to the consumer's interest to a product web-site, where still images of the product are displayed upon linking of the identifying marker to another marker identifying the still image. The identifying marker can be transmitted to the consumer's “BeamBack” device, computer or web-page or directly to the product's web-site.

### CROSS-REFERENCE TO RELATED APPLICATIONS

The present application claims the benefit of U.S. Non-Provisional application Ser. No. 11/524,338 filed Sep. 20, 2006, which is hereby incorporated by reference.

### FIELD OF INVENTION

The present invention is directed to a method and apparatus for the identification and cataloguing of products displayed in television shows, movies and print advertisements for later consumer viewing and purchasing,

### BACKGROUND OF THE INVENTION

Television remains the most effective method to reach a mass audience. However, with the rise of TiVo, DVRs, broadband and video games, and the consumer's new ability to fast forward through commercials, many advertisers are shifting focus away from traditional 30 second commercial spots and looking into other forums. As such, it's becoming harder to sell media based on time-slots and traditional Nielsen ratings. In addition, Networks have a harder time scheduling programs, as customers cherry pick what they want to see and when, time slots become less relevant. Networks need to offer advertisers a variety of new ways to deliver their message, including product placement.

As more and more people skip commercials using such devices as digital video recorders, product placement in television programs is a growing industry. However, the utility of product placement is currently limited to what products the consumer can recognize or what products have a brand name on them. Thus, there is a need for a method by which the products shown in films, television programs, or posters can be identified to the user.

### SUMMARY OF THE INVENTIONS

Accordingly, the present invention is directed to a method and apparatus which allows consumers to identify products placed in television shows, movies, print advertisements or other media and later access a web-site for browsing and purchase of those products.

In a first embodiment, a potential consumer uses a “BeamBack” sending device to “capture” products or items the consumer is interested in. The sending device sends a signal to a media interface. The media interface, in response, transmits coding numbers correlating to the products placed or advertised. The transmitted information are received by the “BeamBack” web-site which maps those coding numbers to further coding numbers corresponding to stills containing the “captured” products or items. Thus, the consumer can be directed to a particular still image in a television program, film, or poster, by pressing a button on a sending device which causes a receiver device to return coded information about the still image or poster that the user is viewing.

In a second embodiment, the consumer can search on the “BeamBack” web-site database by specific product types. Once entered, all such products that were placed in the program will be listed. When the user clicks on that a specific product, the user will see the scene or scenes it appeared in.

In each embodiment, Consumers will also see a beauty shot of the product or item, with detailed info about the product or item.

The present invention, including its features and advantages, will become more apparent from the following detailed description with reference to the accompanying drawings.

### BRIEF DESCRIPTION OF THE DRAWINGS

FIG. 1 is an illustration of an apparatus through which products displayed in media programs can be identified and later purchased by consumers, according to an embodiment of the present invention.

FIG. 2 is an illustration of a flowchart detailing the steps by which products displayed in a media and the product's corresponding information is captured and made available on a website, according to an embodiment of the present invention.

FIG. 3 is an illustration of a flowchart detailing the steps of using a sending device to access information about products from the programs, films, and posters on the system website, according to an embodiment of the present invention.

FIG. 4 is an illustration of a depiction of the correlation between components utilized in the method and apparatus of making a product publicized in a visual or audio media available to a consumer for purchase via a web-site, according to an embodiment of the present invention.

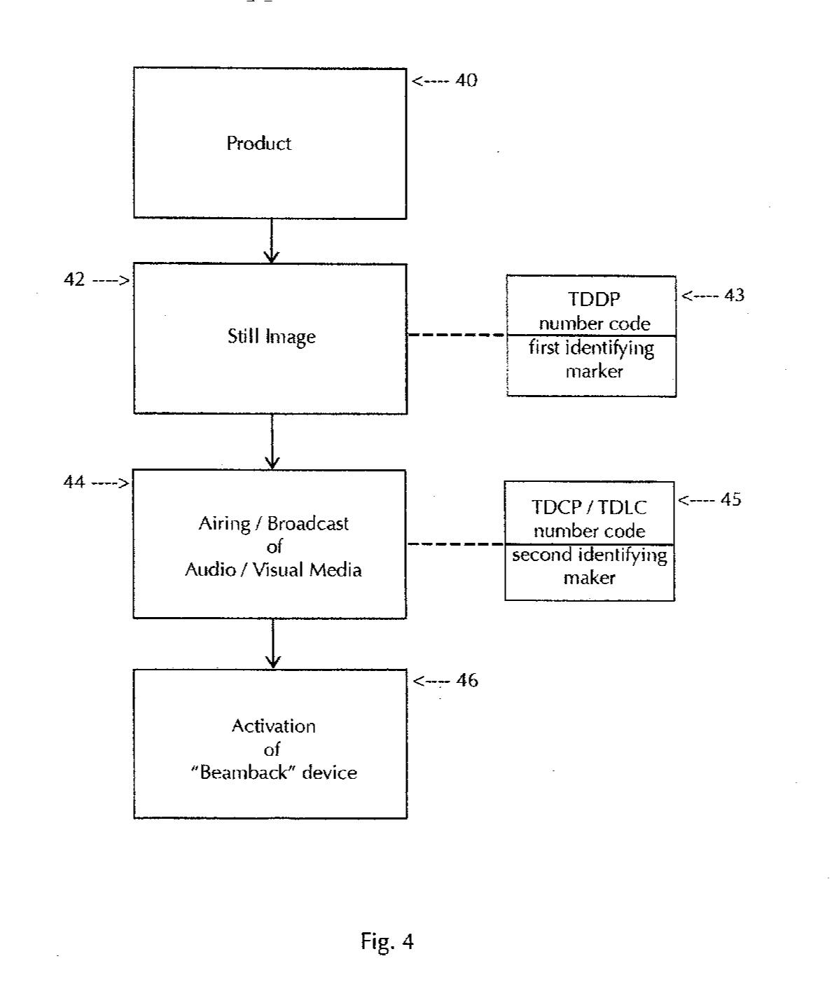

FIG. 5 is a flowchart detailing the steps of interaction between a user and an advertisement in a video or a web page, according to an embodiment of the present invention.

FIG. 6 is a flowchart detailing the steps of interaction between a user and an out-of-home advertisement using a RFID, according to an embodiment of the present invention.

FIG. 7 is a flowchart detailing the steps of interaction between a user and an out-of-home advertisement using RF signal, according to an embodiment of the present invention.

### DETAILED DESCRIPTION OF THE PREFERRED EMBODIMENTS

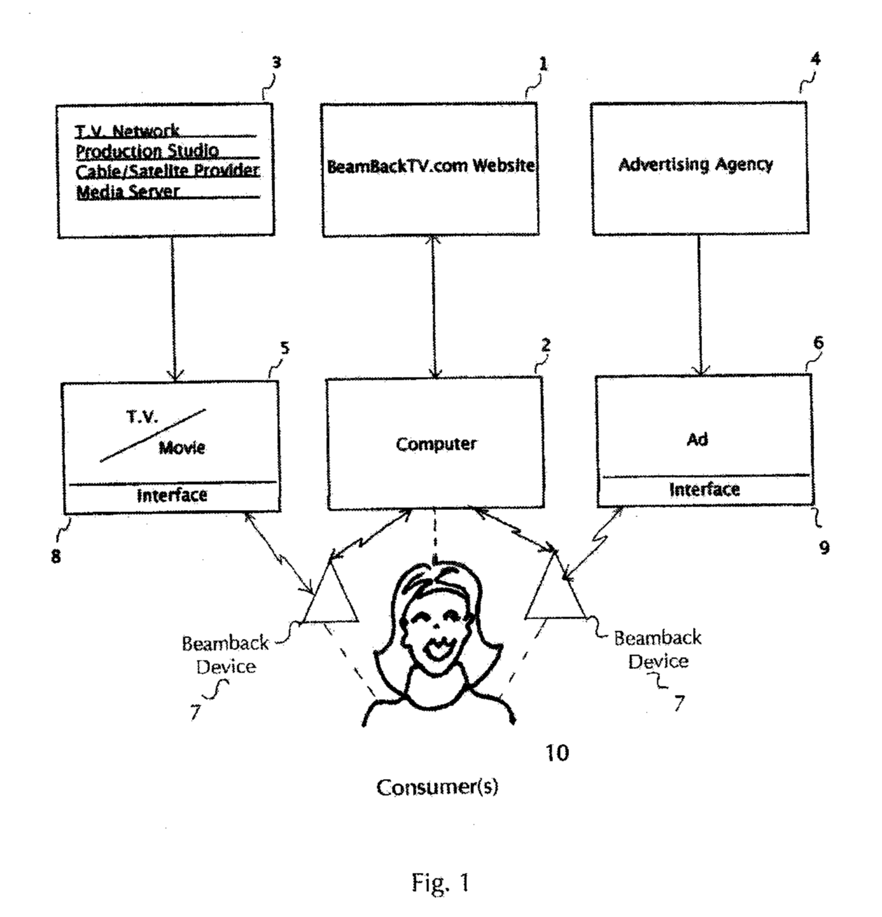

FIGS. 1 through 3 illustrate a method and apparatus through which a consumer can express interest in a placed or advertised product or item and later purchase such product or item through a web-site. The placed products and items can include, inter alia, clothing, accessories, cosmetics worn by the actors, furniture and all other props, wallpaper and paint on the walls, and even locations or destinations. Each product is entered into a searchable database on the web-site.

Referring now to FIG. 1, a “BeamBack” website 1 stores all products and information about the products placed and/or shown in television programs, movies, or print advertisements and displays such products and information through a computer 2 or other appropriate communication means. Television Networks and/or Production Studios 3 and/or Advertising Agencies 4 work in conjunction and coordinate with the “BeamBack” website 1 regarding the products and placement of those products in the television programs, movies, or print advertisements. A Consumer 10 can view such product placement, for example, in television programs through a television 5, and in print media through advertisements 6. It is to be understood, of course, that products can be viewed and/or displayed in any form of media, including for instance, movies, shows, radio, etc. The content can be streamed, downloaded, broadcasted, or be part of cable or satellite programming, as well as content/ads specifically inserted by an ad server, whether as its own segment or as an overlay over the existing programming.

The Consumers 10 utilize a “BeamBack” device 7 to express interest in the placed product through an interface 8 or interface 9. For example, upon activation the “BeamBack” device 7 sends a signal to the appropriate interface 8 or 9. Preferably the “BeamBack” device 7 is a signal transmitter, operated for instance by push button, which the Consumer 10 utilizes while viewing a television program, film or poster. This sending device can be a component of a television remote control unit, cellular telephone, personal digital assistant, and car key fob, a device connected to an iPod/MP3 player or a computer program. The Interface 8 can be a cable or satellite box, or a stand-alone device that understands what channel the TV or cable box is on, while interface 9 can be an IR receiver placed on the advertisement display. It is to be understood, of course, that there can be many different embodiments of both the sending device and/or signal transmitter and the receiving interface. Accordingly, by pressing a button on a sending device it will be possible to “Send, Receive or Exchange” information.

Furthermore, each sending device 7 will have a method of transferring stored codes (described below) to the computer or web-enabled device 2. Such method could be a USB or similar wired connection, an Infrared or Bluetooth wireless connection, or another wireless option. For example, a cell phone may be used for this purpose. Alternately, the signal sent from the receiver unit 8 or 9 could, at the user's request, send both an infrared and Radio signal such as “Bluetooth” at the same time. This way the user may press a button on the TV remote, but the return signal from the interface will be sent to a device of choice, such as the user's computer 2 rather than to the device 7. The return signal can be in the form of email, text or push message, etc. In this fashion, the sending device 7 may not need to have a storage capacity. By sending the number code directly to a computer 2, there will be no need to later transfer the number code from the device 7.

In addition, to aid in operation of sending and receiving number codes, each device 7 used to send a code to the receiver units 8 or 9 has its own unique I.D. code. This avoids other devices 7 owned by other consumers 10 from receiving unwanted signals. As the receiver unit 8 or 9 sends back the number code to the initiating device 7, it adds a code that identifies the signal to the user's sending device 7.

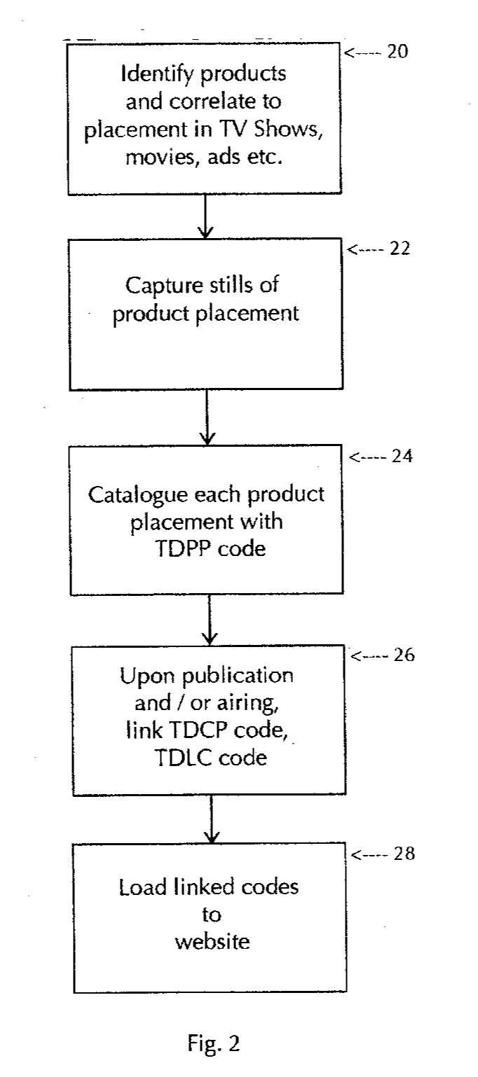

Referring now to FIG. 2, an embodiment of a method by which placed products are identified and made available for consumers is shown. In step 20, products are identified and their appearance in television shows, movies and print advertisements is correspondingly correlated. Preferably, such correlation between identified products and their appearance is accomplished by the Networks/Studios 3, Agencies 4 and the Web Site 1 working in conjunction. For instance, participating producers, advertisers, prop staff and product placement agencies can provide information about all the products that are in the television program, film or advertisement. In addition, the product manufacturers can provide additional information regarding the products and their features.

Having identified and developed product placement, in step 22 still images of all such placed products are captured. Preferably, the stills captured are for every change of camera angle or change in a scene. For example, a new still would be captured when an actor walks into a scene of a program, or if props are changed or added. Thus, a new still is formed when the camera is panned around the scene and new props and or actors come into view. Accordingly, these “screen grabs” from each television program or film can preferably be captured when the production is edited.

The stills displaying the identified products having been captured, in step 24 each still is assigned an identifying marker. Preferably such marker can consist of a Time, Date, Percentage and Production (TDPP) code number. Such TDPP code number, or alternative marker, allows for reference as to between the placed product and the program, movie or advertisement the placed product is shown in. The time and date can refer to the time and date the still is captured or when the program, movie or advertisement is to run. The percentage figure is for an edited film or television program to denote at what point in the program the still occurs, for instance, as a percentage of the program's overall run time. Thus this percentage code allows for the identification of stills from programs that have been re-edited for other channels or purposes. Accordingly, each and every identified product or item that appears in each still (or poster or store) is catalogued and identified by a TDPP code number whenever it appears in the program or film.

The still images can then be added to the web site 1 as the show is airing, so, for instance, users cannot determine the ending to first-run programs ahead of time. This data can also be accessible through the website for consumers.

In step 26, upon airing and/or publication of the television show, movie or advertisement, the TDPP code number (or other identifying marker) is linked directly to a Time, Date, Channel and Provider (TDCP) code number or a Time, Date, Location and Client (TDLC) code number. The TDCP code number can be utilized when a program or movie is shown via a cable or satellite provider, while the TDLC code number can be utilized for an advertisement displayed by a poster or in a magazine. Alternatively, the TDCP code can also be related to a DVD movie, streamed movies, music, radio and video games, etc., while alternatively the TDLC code can be related to advertisements at kiosks or stores, or for information exchange applications such as swapping, giving and receiving business card information. This same identifying coding technique can be carried though to streaming web content, IPTV, cell phone radio, TV plus, posters, bill boards and in-store content and promotions. It is to be understood, of course, that any other identifying markers or methods may be utilized for the purpose of identifying when and where the identified products are aired, broadcast, shown or placed.

Once the linking between the identifying code numbers (or other identifying marker) is accomplished, in step 28 all of the linked identifying code numbers are transmitted to the “BeamBack” website 1 for storage and later use as described below.

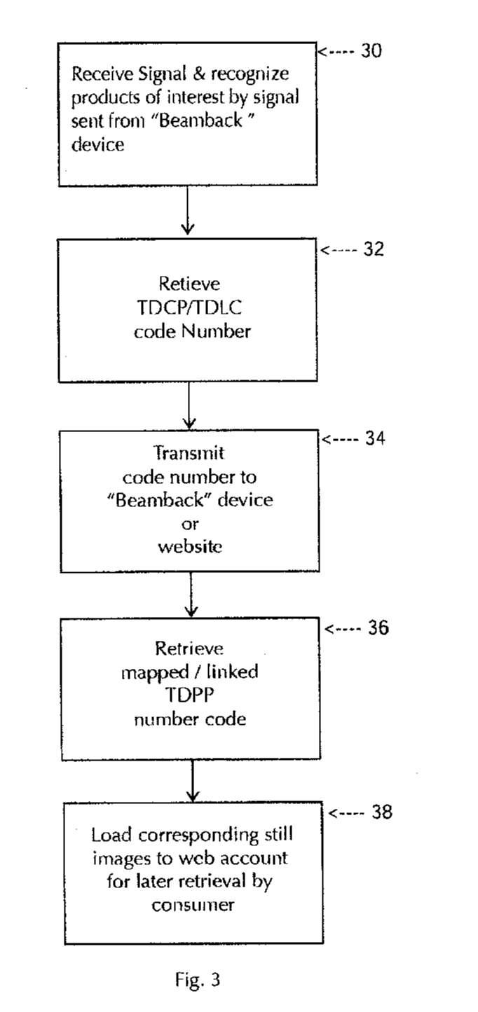

Referring now to FIG. 3, a method by which a consumer 10 is able to express interest in a placed product for possible later purchase is shown. Thus, in step 30, interface 8 or 9, as the case may be, receives a signal transmitted by a “BeamBack” device 7 upon consumer 10 expressing interest during viewing in a placed product in a television show, movie or print advertisement. In step 32 the interface 8 or 9 recognizes the product interest signal sent by the sending device 7 and retrieves the TDCP or TDLC code number assigned to the television show, movie or print advertisement, and, in step 34, returns that retrieved code number to the device 7. while the identifying code number may be sent to the consumers sending device, it is to be understood that alternatively the code number may be sent directly to the consumer's e-mail or “BeamBack” web-site account. Such alternative embodiment can be accomplished through a cable box or other online or wireless device.

In step 34 then, having received a signal from a “BeamBack” device 7 and retrieved a TDCP/TDLC number code corresponding to the product placement the consumer 10 has expressed interest in, the TDPP number code mapped and/or linked to TDCP/TDLC number code is retrieved. As described above, the TDPP number code relates to a still image from a television program, movie or print advertisement, and in step 36 the corresponding still image are loaded to the consumer 10′s “BeamBack” web-site account 1. In this manner then, the TDLC and TDCP codes, once transferred from the user's computer or web-enabled device 2 to the web-site 1, will enable the user to navigate to the selected stills for each TV show, film and/or advertisement that had been selected using the sending device. A program will enable a web browser to automatically import the codes so that the user will very easily find the selected stills.

Accordingly, there are several embodiments by which the consumer 10 can access the placed products displayed on programs, film, or poster. In the preferred embodiment, described above, the consumer 10 can express interest in and find out about products placed in a movie, TV show, DVD, radio, etc., including posters on a phone kiosk, posters in the subway, etc., by utilizing the “BeamBack” device 7 with an interface 8 or 9. In an alternative embodiment, the consumer 10 logs into the “BeamBack” website 1, and chooses a program, film or poster from a menu. The user is then presented with all the still images from that program, film, or poster in thumbnail form.

In another means of accessing the product database, a user can select a program, film or poster from the website menu, and then enter the name of a product or product type, for example, a “watch”. The website will search the database of products for all watches displayed on that program, film or poster, and present a list to the user. When the user clicks on an entry in this list, the website will return information about that product, the still images of the scenes in which that product appeared, and a beauty shot of the item. This embodiment gives users the option to look for other products of interest.

Once the consumer 10 is on the “BeamBack” website 1, the user can click on any still image from any program. As the user clicks a thumbnail image, that will produce a larger main image of the still. Then by moving the mouse over that main image of the still, each displayed placed product and/or item in the still is highlighted and information is presented about that product or item. When the user clicks on that item, more information is presented, and the user is given the opportunity to add it to a shopping cart, add it to a wish list, or hold the information for later use, as well as other possible option.

There are yet additional features which are possible using the method and apparatus of the present invention. For instance, if a particular product shown on the program, film or poster is out of date, the product database will have information about the model that is shown in the movie or program, as well as details on the newest similar model. By maintaining this link, as fashion and technology products especially change rapidly, the newest version of any product is always available on the website.

Thus, the present invention enables the user to identify any product or item seen or heard in any visual or audio media, and later make a purchase via the Internet of that product or item. Such a method and apparatus greatly enhances the utility of product placement.

In addition, there are many embodiments to extend the usefulness of the method of sending and retrieving data via the present invention. For instance, by using the sending device 7 in a store or restaurant or other business, the user could get store information without picking up a business card or leaflet, or request information from a store even if the store was closed. Alternately, the user could subscribe to an email list for that store or could give shipping information to a carrier or contact data to a business, for example, the service department. Additionally, the user can exchange contact information with friends and business contacts. In other embodiments, customers can receive coupon, catalogue or store location link.

This method may also be used to trigger a phone app, making it easy and convenient for the user to receive the additional ad information whether they are using a computer or a phone. This method may also be used to place a reminder ad or trigger near video player on the computer or phone s well.

What should be emphasized about interacting with ads, commercials, RF and RFID options is that any relevant information may be sent to the user in a variety of ways. So the viewer experiences not just the ad itself, but a host of different ways to receive information stemming from receiving a simple coupon to receiving in-depth company information. It's entirely up to the advertisers and receiver's preferences. For example, a logo could be used to identify the company sending the information. The invention does not limit the type of information or product nor type of ads. It can be any still-image ad, such as a logo or a picture or video ads.

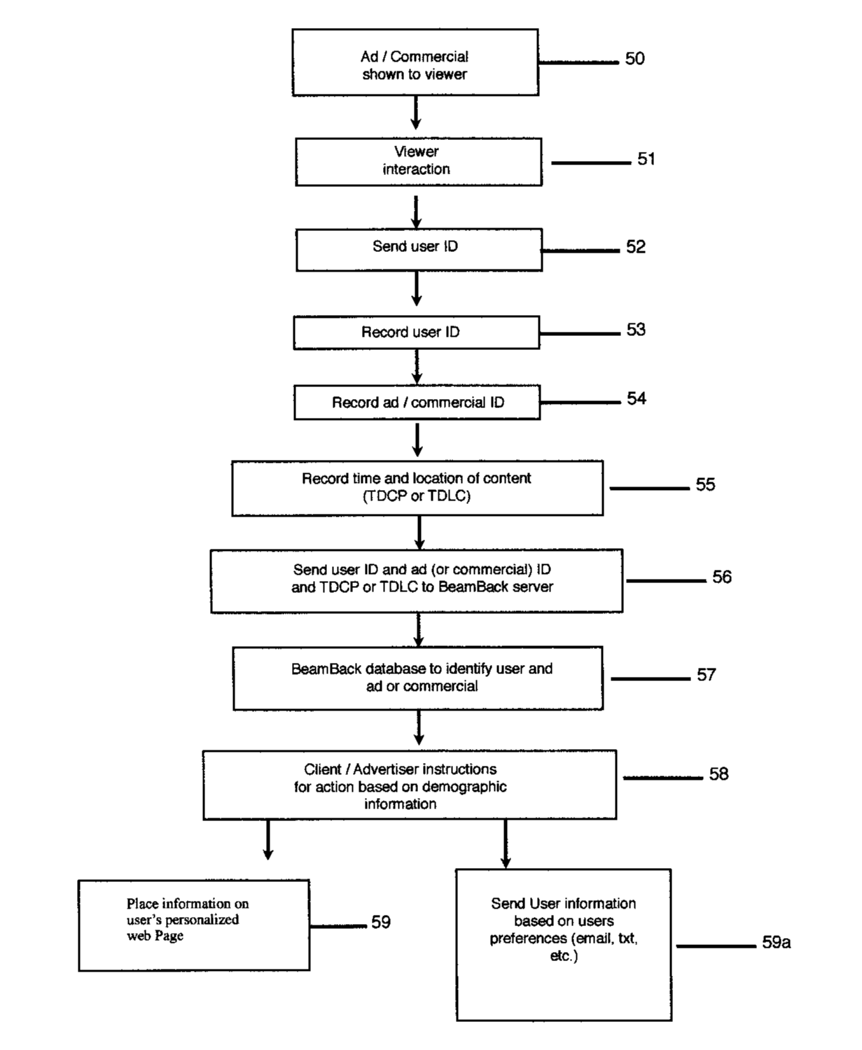

Another embodiment of the invention is shown in FIG. 5. In this embodiment, the user has the option of bookmarking a commercial or advertisement using a predetermined identification number or created dynamically. The commercial or advertisement can be streamed, downloaded, broadcast, part of cable or satellite content, or any content that is inserted by an ad server dynamically, which can be done using a program such as Flash technology or using a overlay screen web technology.

In step 50, a viewer is shown an ad or commercial as part of the programming. When the viewer sees something he is interested in, without leaving the programming, the viewer can interact with the ad in step 51. The interaction can be through a BeamBack device or through interaction with device displaying the media. For example, the viewer may interact by clicking the mouse or a key on the keyboard, such as the space bar, or enter key, when the viewer is viewing on the computer. The action in step 51 taken by the viewer triggers information to be sent in step 52 to a remote server. The information sent can include identifying information related to the advertisement, product or services, as well as user information and other product or relevant information. Other information, such as information related to the advertisement itself, such as time and location of the content displayed or related to the time and location, medium used to display the content, can also be sent.

The information sent to remote server can then be recorded in steps 53, 54 and 55, which can happen sequentially or concurrently. For example, when using a media player, such as Flash or Silverlight, the media player records when the user clicks. It records the media player's id, the ad id, time and other information that's then sent to a remote server, for example a BeamBack, which contains databases of information which can send matched information to the user. Then sending out a email or text etc. (the user id is from the person signing up with BeamBack or signing in though Facebook etc.) In step 56, the same information recorded is sent to the BeamBack server, which has a database of information related to the user and advertisements. Beamback server can optionally be the same as the remote server, thereby, step 56 can be skipped. Using the information received, in step 57, the correct product related to the advertisement is identified. The product information can then be sent to user's personalized page in step 59. Additionally, users can receive information based on user's preference in step 59a. Step 59 may be skipped based on user's preferences.

Furthermore, the process can optionally include step 58, which checks for advertiser instruction, before steps 59 or step 59a. Advertiser instruction may require specific information to be sent (e.g. a printable or scannable coupon) which can be customized by the advertiser based on different factors, such as on demographic data and/or type of advertisement.

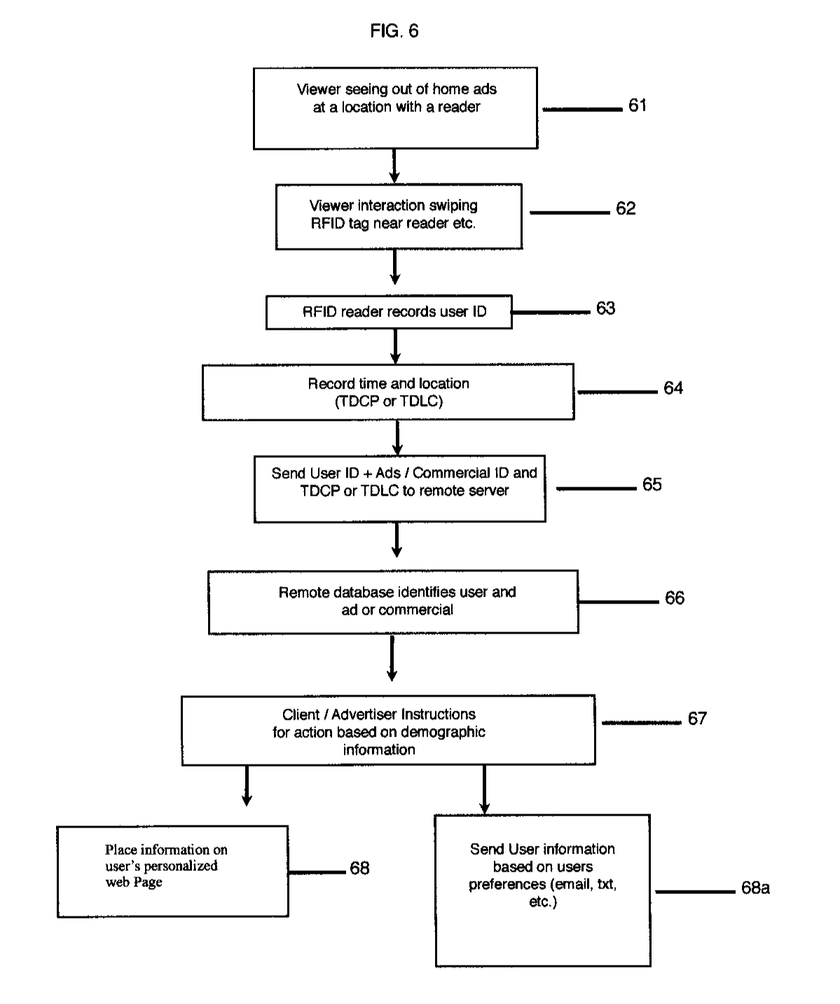

In another embodiment as shown in FIG. 6, radio frequency identification (RFID) can be used in combination with TDLC for out of home ads. A RFID reader 60 can be located near a display of an advertisement, for instance at a bus stop or kiosk. Reader 60 may be used to identify posters d ads and video or other interactive ads at the kiosk and or the user if the user uses a device that has a RFID tag or label attached to it, which can identify the user by device. In step 62, user's device's RFID tag is read. One example of viewer's interaction to trigger the RFID tag being read is when the viewer interacts with the reader 60 by swiping the RFID tag near the reader. In steps 63 and 64, RFID reader 60 records the RFID tag ID and TDLC information. In step 65 user ID, advertisement ID or location ID and TDCP or TDLC are sent to a remove server, such as the BeamBack server. These steps can happen simultaneously or sequentially. Once the remote server recognizes the tag and the advertisement ID through searching its database in step 66, the advertisement is sent to the user identified who initially triggered a response with his or her tag near the ad. The advertisement can be sent to user's personalized page in step 68. Or as in other embodiments, the user can then get a response in the form of email, text, etc. about the product/service they have requested as shown in step 68a. That information may be for a movie, coupon etc., or even the nearest movie theater with that particular advertised movie showing and the times/locations it's showing. By using a reader in a location such as a kiosk, it allows anyone with a RFID tag to use it.

Furthermore, the process can optionally include step 67, which checks for advertiser instruction, before steps 68 or step 68a. Advertiser instruction may require specific information to be sent (e.g. a printable or scannable coupon) which can be customized by the advertiser based on different factors, such as on demographic data and/or type of advertisement.

In another embodiment, the RFID reader may be placed near the entrance of a venue, such as a retail store. It may be used for ticketing at venues, “checking in” the user in effect, as he or she enters the building/designated area etc. Eventually when phones with RFID readers in them are common the method may still be used to read the tag in the phone. The location code could also still be accessed when there is a weak or absent GPS signal.

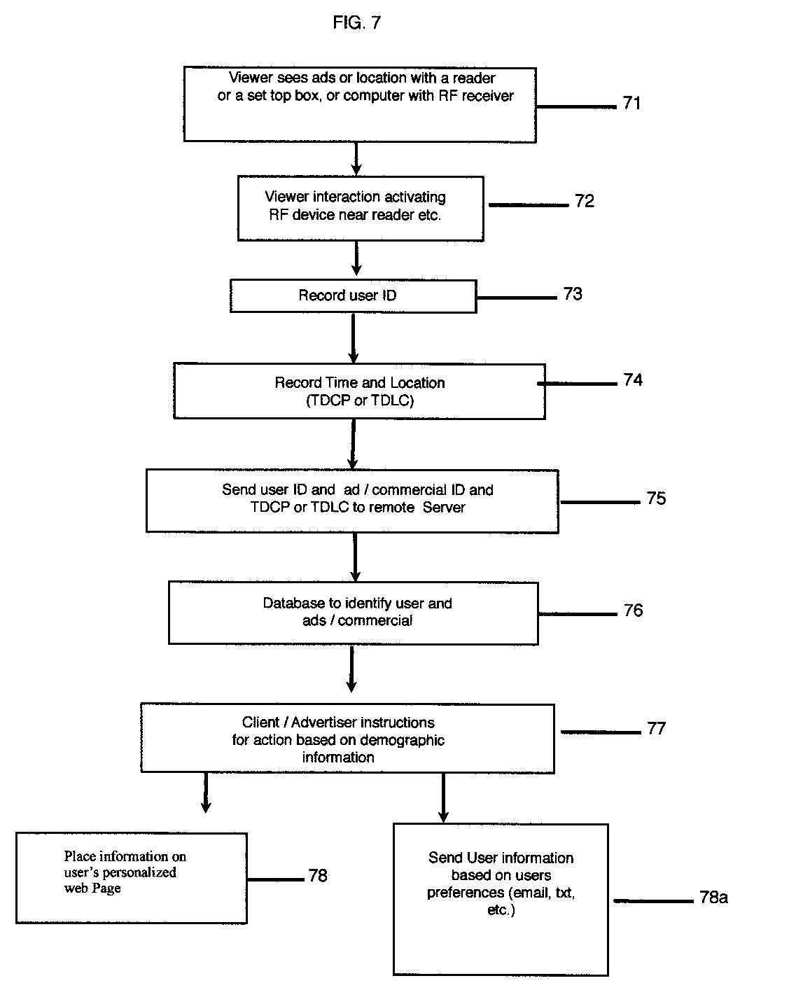

In yet another embodiment, radio frequency can be used for communication. FIG. 7 illustrates the process of transmitting information using radio frequency. When a user wishes to receive information related to an advertisement enable to receive information through radio frequency, the user can use a RF enabled device to communicate. The user interacts with the ad, requesting additional information in step 71 using a RF enabled device 70. For example, the user may push a button. The pushing of the button, or other interactions that activates the RF enabled device, triggers the sending of identifying information of the device to the RF receiver 70a, step 72. In steps 73, 74, relevant information, such as user ID, time and location of the ad/commercial displayed, are recorded. These steps can happen simultaneously or sequentially.

In step 75, RF receiver 70a sends user ID, advertisement/commercial id and TDCP or TDLC to a remote server, which can be the BeamBack server, which contains a database storing user id information and advertisement information. Once the server searches and recognizes the user id and advertisement identification, it sends product information related to the advertisement to the user in step 76. The product information is displayed on user's personalized webpage, step 78 or according to user preferences 78a such as via message texting or email. In addition, step 77 of checking advertiser instructions, as described in other parts of the specification, can be optionally included before steps 78 and 78a.

This method could also be used as a check-in type option to tell the store or friends where the user is located. The RF device could be attached to a phone or built into the phone/key-fob etc. with more than one button. For example, the device can have three buttons for use in interactive games and voting. One button may send the BeamBack user code, while the other two can be used for answering “yes” or “no” for instance. The “yes” or “no” button may optionally send the user ID along with the response. If the RF device is embedded in another device, such as a phone or remote, etc., it can be controlled in many other ways, by pressing the button or by a phone application

In the foregoing description, the method and apparatus of the present invention have been described with reference to a number of examples that are not to be considered limiting. Rather, it is to be understood and expected that variations in the principles of the method and apparatus herein disclosed may be made by one skilled in the art and it is intended that such modifications, changes, and substitutions are to be included within the scope of the present invention as set forth in the appended claims. The specification and the drawings are accordingly to be regarded in an illustrative rather than in a restrictive sense.

What is claimed is:

1. A method of bookmarking an advertisement of interest by a user for later use, the method comprising the steps of:
transmitting a signal containing a first identification information and a second identification information;
retrieving information relate to the identity of the user using the first identification information;
retrieving information related to the advertisement of interest using the second identification information;
communicating information related to the advertisement of interest to the user.

2. The method of claim 1, further comprising placing information related to the advertisement of interest on a personal web site.

3. The method of claim 1, wherein e-mail is used to communicate information related to the advertisement of interest to the user.

4. The method of claim 1, wherein push messaging is used to communicate information related to the advertisement of interest to the user.

5. The method of claim 1, wherein text messaging is used to communicate information related to the advertisement of interest to the user

6. The method of claim 1, wherein the first identification information contains a RFID.

7. The method of claim 1, wherein the first identification information contains information on the identity of the device.

8. The method of claim 1, further comprising retrieving information related to the user's communication preference, wherein communication is done in accordance to said preference.

9. The method of claim 1, wherein the second identification information contains information related to the location of the advertisement.

10. The method of claim 1, wherein the second identification information contains date and time information.

11. The method of claim 1, further comprising the user interaction to trigger the transmittal of the first and second identifying information.

12. A method of bookmarking an advertisement of interest by a user for later use, the method comprising the steps of:
a user interacting with a RFID reader located near an advertisement;
the RFID reader recording information related to the user;
the RFID reader recording information related to the location and time of the of the user's interaction;
the RFID reader transmitting recorded information and information to a remote server;
the remote server retrieving information relate to the identity of the user, location and the advertisement;
communicating information related to the advertisement of interest to the user based on user's preferences.

13. The method of claim 12, further comprising retrieving information related to an advertiser's preferences, wherein additional information based on the advertiser's preferences are communicated to the user.

14. The method of claim 12, wherein communication information related to the advertisement of interest is done through email.

15. The method of claim 12, wherein communication information related to the advertisement of interest is done through text messaging.

16. The method of claim 12, wherein communication information related to the advertisement of interest is done through display on the user's website.

17. A method of bookmarking an advertisement of interest by a user for later use, the method comprising the steps of:
using a RF enabled device;
sending identifying information to a RF receiver;
the RF receiver records the identifying information;
the RF receiver transmitting the identifying information to a remote server;
the remote server uses the identifying information to retrieve information related to the identity of the user, location and the advertisement;
the remote server communicating the advertisement to the user based on user's preferences.

18. The method of claim 17, the identification information includes information on the user and the advertisement.

19. The method of claim 17, wherein communication information related to the advertisement of interest is done through text messaging.

20. The method of claim 17, wherein communication information related to the advertisement of interest is done through display on the user's website.
